(19) United States
(12) Patent Application Publication
(10) Pub. No.: US 2026/0074190 A1
(43) Pub. Date: Mar. 12, 2026

(54) NEGATIVE ELECTRODE FOR LITHIUM SECONDARY BATTERY, METHOD FOR MANUFACTURING NEGATIVE ELECTRODE FOR LITHIUM SECONDARY BATTERY, AND LITHIUM SECONDARY BATTERY COMPRISING NEGATIVE ELECTRODE

(71) Applicant: LG ENERGY SOLUTION, LTD., Seoul (KR)

(72) Inventors: Chan Soo JUN, Daejeon (KR); Yohan KWON, Daejeon (KR); Young Jae KIM, Daejeon (KR); Jaewook LEE, Daejeon (KR)

(21) Appl. No.: 18/992,931

(22) PCT Filed: Dec. 13, 2023
(86) PCT No.: PCT/KR2023/020506

§ 371 Date: Dec. 3, 2025

(30) Foreign Application Priority Data
Dec. 26, 2022 (KR) 10-2022-0184859

(51) Int. Cl. H01M 4/36; H01M 4/02; H01M 4/04; H01M 4/38; H01M 4/40; H01M 4/583; H01M 10/0525

(52) U.S. Cl. CPC H01M 4/364; H01M 4/0404; H01M 4/366; H01M 4/386; H01M 4/405; H01M 4/583; H01M 10/0525; H01M 2004/021; H01M 2004/027

(57) ABSTRACT

A negative electrode for a lithium secondary battery, a method for manufacturing a negative electrode for a lithium secondary battery, and a lithium secondary battery including a negative electrode, are provided. The negative electrode includes a negative electrode current collector layer, a first negative electrode active material layer provided on a surface of the negative electrode current collector layer, and a second negative electrode active material layer provided on a surface of the first negative electrode active material layer opposite to a surface of the first negative electrode active material layer facing the negative electrode current collector layer.

### CROSS-REFERENCE TO RELATED APPLICATIONS

The present application is a National Phase entry pursuant to 35 U.S.C. § 371 of International Application No. PCT/KR2023/020506, filed on Dec. 13, 2023, and claims priority to and the benefit of Korean Patent Application No. 10-2022-0184859 filed in the Korean Intellectual Property Office on Dec. 26, 2022, the entire contents of each of which are incorporated herein by reference in their entirety for all purposes as if fully set forth herein.

### TECHNICAL FIELD

Accordingly, the present disclosure relates to a negative electrode for a lithium secondary battery, a method for manufacturing a negative electrode for a lithium secondary battery, and a lithium secondary battery including a negative electrode.

### BACKGROUND

Due to the rapid increase in the use of fossil fuels, the demand for the use of alternative energy or clean energy is increasing, and as part of this trend, the fields that are being studied most actively are the fields of power generation and power storage using an electrochemical reaction.

Currently, secondary batteries are representative examples of electrochemical devices that utilize such electrochemical energy, and the range of use of secondary batteries is gradually expanding.

Along with the technology development and the increase in demand for mobile devices, the demand for secondary batteries as an energy source is sharply increasing. Among such secondary batteries, lithium secondary batteries having high energy density and voltage, long cycle life, and low self-discharging rate have been commercialized and widely used. In addition, research is being actively conducted on methods for manufacturing high-density electrodes having higher energy density per unit volume as electrodes for such high-capacity lithium secondary batteries.

In general, a secondary battery includes a positive electrode, a negative electrode, an electrolyte, and a separator. The negative electrode includes a negative electrode active material for intercalating and deintercalating lithium ions to and from the positive electrode, and silicon-based particles having a high discharge capacity may be used as the negative electrode active material.

In particular, in response to the demand for high-density energy batteries in recent years, research has been actively conducted on methods for increasing capacity by using silicon-based compounds such as Si/C or SiOx having a capacity 10-fold or higher than that of graphite-based materials, in combination as a negative electrode active material. When compared with graphite-based materials that are typically used, however, the silicon-based compounds that are high-capacity materials are excellent in capacity characteristics, but can undergoe rapid volume expansion during charging processes resulting in disconnection of the conductive path, which can cause in deterioration in battery characteristics, and accordingly, the capacity may decrease from the initial stage. In addition, for a silicon-based negative electrode, when the charging and discharging cycle is repeated, the lithium ions may not be uniformly charged in the depth direction of the negative electrode and reactions proceed on the surface, so that degradation in surface is accelerated, and therefore, a need exists for improvement in performance in terms of battery cycle.

Therefore, in order to address such problems that can occur when a silicon-based compound is used as a negative electrode active material, a variety of methods have been discussed, such as a method of controlling a drive potential, a method including additionally coating a thin film on an active material layer, a method of suppressing volume expansion itself such as a method of controlling a particle diameter of a silicon-based compound or a development of a binder capable of suppressing volume expansion of a silicon-based compound to prevent disconnection of a conductive path. In addition, research is being conducted to supplement the life characteristics of the silicon-based negative electrode by limiting a proportion of the silicon-based active material used during initial charging and discharging by a method of pre-lithiating the silicon-based active material layer, and imparting a reservoir role.

However, since the above methods may make the performance of the battery somewhat deteriorate, the applications are limited, so that there is still a limitation in commercialization of manufacturing a negative electrode battery having a high content of a silicon-based compound. In addition, as the proportion of the silicon-based active material included in the silicon-based active material layer increases, pre-lithiation is concentrated on the surface of the negative electrode, so that the silicon-based active material on the surface is rather damaged, and as non-uniform pre-lithiation occurs, a problem with the improvement of life characteristics occurs.

Accordingly, research is also underway on a method of using a silicon-based active material and additionally using a negative electrode active material layer that serves as a buffer layer. However, it is very difficult in terms of process to put any layer of a thinner film on top of the silicon-based active material layer formed thin for rapid charging, making it difficult to perform production through actual processes and products.

Therefore, there is a need for research on a method in which even when a silicon-based compound is used as an active material in order to improve capacity characteristics, a decrease in capacity characteristics is not caused, and cycle performance can be improved by preventing deterioration in the electrode surface during charging and discharging cycles, and even when a double active material layer is used, a more uniform and thinner coating can be formed.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Aspects of the present disclosure relate to a negative electrode for a lithium secondary battery, a method for manufacturing a negative electrode for a lithium secondary battery, and a lithium secondary battery including a negative electrode, capable of using the silicon-based active material for a negative electrode, and maximizing capacity characteristics, which is a main purpose of using a silicon-based active material, while also preventing deterioration in electrode surface during charging and discharging cycles, which is a problem in the related art, and furthermore, while enabling a uniform two-layered negative electrode active material layer and a thin film coating for ensuring rapid charging performance and processability.

An exemplary embodiment of the present disclosure provides a negative electrode for a lithium secondary battery, the negative electrode including: a negative electrode current collector layer; a first negative electrode active material layer provided on a surface of the negative electrode current collector layer (or even on both surfaces of the negatice electrode current collector); and a second negative electrode active material layer provided on a surface of the first negative electrode active material layer opposite to a surface of the first negative electrode active material layer facing the negative electrode current collector layer, wherein the first negative electrode active material layer includes a first negative electrode active material layer composition including a first negative electrode active material, and the second negative electrode active material layer includes a second negative electrode active material layer composition including a second negative electrode active material, wherein the first negative electrode active material includes one or more selected from the group consisting of SiOx (x=0) and SiOx (0<x<2), and includes SiOx (x=0) in an amount of 95 parts by weight or more based on of 100 parts by weight of the first negative electrode active material, wherein the second negative electrode active material includes a mixture of one or more selected from the group consisting of a carbon-based active material, a silicon-based active material, a metal-based active material capable of alloying with lithium, and a lithium-containing nitride, wherein the second negative electrode active material layer has a first surface and a second surface, and wherein the second surface of the second negative electrode active material is facing the first negative electrode active material layer, and the first surface of the second negative electrode active material layer is opposite to the second surface, wherein the first surface and the second surface each include a non-uniform surface, respectively, and wherein the second negative electrode active material layer satisfies a non-uniformity criteria expressed by Formula 1 below:

$$0 μm \leq \vert C - ( A + B / 2 ) \vert \leq 10 μm \qquad Formula 1$$

in Formula 1 above,
A refers to a longest distance (μm) between the first surface and the second surface,
B refers to a shortest distance (μm) between the first surface and the second surface, and
C refers to an average thickness (μm) of the second negative electrode active material layer.

Another exemplary embodiment provides a method for manufacturing a negative electrode for a lithium secondary battery, the method including: preparing a negative electrode current collector layer; forming a first negative electrode active material layer by applying a first negative electrode active material layer composition to surface (or both surfaces) of the negative electrode current collector layer using a first coating composition; and forming a second negative electrode active material layer by applying a second negative electrode active material layer composition to a surface of the first negative electrode active material layer that is opposite to a surface of the first negative electrode active material layer that is in contact with the negative electrode current collector layer using a second coating composition, wherein the first negative electrode active material includes one or more selected from the group consisting of SiOx (x=0) and SiOx (0<x<2), and includes SiOx (x=0) in an amount of 95 parts by weight or more based on of 100 parts by weight of the first negative electrode active material, wherein the second negative electrode active material includes a mixture of one or more selected from the group consisting of a carbon-based active material, a silicon-based active material, a metal-based active material capable of alloying with lithium, and a lithium-containing nitride, wherein in the step of forming the first negative electrode active material layer by applying the first negative electrode active material layer composition, a liquid thickness of the first coating composition is 50 μm or greater and 100 μm or less, and wherein in the step of forming the second negative electrode active material layer by applying the second negative electrode active material layer composition to the surface of the first negative electrode active material layer opposite to the surface in contact with the negative electrode current collector layer, a liquid thickness of the second coating composition is 10 μm or greater and 60 μm or less.

Finally, there is provided a lithium secondary battery including a positive electrode; the negative electrode for a lithium secondary battery according to aspects of the present disclosure; a separator provided between the positive electrode and the negative electrode; and an electrolyte.

The negative electrode for a lithium secondary battery according to an exemplary embodiment of the present disclosure has a double-layered active material layer composed of the first negative electrode active material layer and the second negative electrode active material layer. In particular, the first negative electrode active material included in the first negative electrode active material layer includes one or more selected from the group consisting of SiOx (x=0) and SiOx (0<x<2), and includes SiOx (x=0) in an amount of 95 parts by weight or more based on 100 parts by weight of the first negative electrode active material, and the second negative electrode active material included in the second negative electrode active material layer includes a mixture of one or more selected from the group consisting of a carbon-based active material, a silicon-based active material, a metal-based active material capable of alloying with lithium, and a lithium-containing nitride.

The negative electrode for the lithium secondary battery according to aspects of the present disclosure includes a double-layer active material layer having a specific composition and content as described above. In particular, the first negative electrode active material layer can include a high content of SiOx (x=0), so that the advantages of high capacity, high density, and rapid charging can be retained as they are. Furthermore, silicon-based and/or carbon-based active materials, and the like are included in the second negative electrode active material layer, so that degradation in the electrode surface can be prevented during charging and discharging cycles, and uniformity can also be improved during pre-lithiation.

Above all, in the negative electrode for a lithium secondary battery according to aspects of the present disclosure, the second negative electrode active material layer may satisfy the non-uniformity criteria of Formula 1 above. In other words, according to certain aspects, the first negative electrode active material layer has a silicon-based negative electrode and is coated within a thin thickness range. In this case, a problem can arise in forming the second negative electrode active material layer as a thin film on top of the silicon-based negative electrode. However, when performing coating by the method according to aspects of the present disclosure (by controlling a liquid thickness and a core thickness of the coating composition), the non-uniformity criteria of Formula 1 above is satisfied, and the second negative electrode active material layer can be coated more uniformly and thinly on top of the first negative electrode active material layer.

Accordingly, a lithium secondary battery including the negative electrode can satisfy optimal capacity characteristics, which are the advantage of a Si negative electrode, and at the same time, can satisfy cycle characteristics.

As such, the negative electrode for a lithium secondary battery according to aspects of the present disclosure may have the feature that the second negative electrode active material layer is coated more uniformly and thinly as a thin film on top of the first negative electrode active material layer to configure a double-layer in order to address a problem of degradation in surface, a problem of uniformity during pre-lithiation and a problem of life characteristics, which problems are disadvantages when a high content of Si particles is applied to an electrode, while taking an advantage of an electrode to which the high content of Si particles is applied as a single-layer active material.

### BRIEF DESCRIPTION OF DRAWINGS

FIG. 1 is a view showing a stack structure of a negative electrode for a lithium secondary battery according to an exemplary embodiment of the present disclosure.

FIG. 2 is a view showing a stack structure of a negative electrode for a lithium secondary battery according to an exemplary embodiment of the present disclosure.

FIG. 3 is a view showing a SEM photograph of a negative electrode for a lithium secondary battery according to an exemplary embodiment of the present disclosure.

FIG. 4 is a flowchart showing a wet on dry process according to an exemplary embodiment of the present disclosure.

FIG. 5 is a flowchart showing a wet on wet process according to an exemplary embodiment of the present disclosure.

### EXPLANATION OF REFERENCE NUMERALS AND SYMBOLS

10: second negative electrode active material layer
20: first negative electrode active material layer
30: negative electrode current collector layer
32: surface of negative electrode current collector layer
34: surface of first negative electrode active material layer facing the negative electrode current collector layer
36: surface of first negative electrode active material layer opposite the surface facing the negative electrode current collector layer
38: second surface of the second negative electrode active material layer facing the first negative electrode active material layer
40: first surface of the second negative electrode active material layer opposite to the second surface of the second negative electrode active material layer
100: negative electrode for lithium secondary battery

### DETAILED DESCRIPTION

Before describing aspects of the present disclosure, some terms are first defined.

When one part “includes”, “comprises” or “has” one constituent element in the present disclosure, unless otherwise specifically described, this does not mean that another constituent element is excluded, but means that another constituent element may be further included.

In the present disclosure, ‘p to q’ means a range of ‘p or more and q or less’.

In this disclosure, the “specific surface area” is measured by the BET method, and specifically, is calculated from a nitrogen gas adsorption amount at a liquid nitrogen temperature (77K) by using BELSORP-mini II available from BEL Japan, Inc. That is, in the present disclosure, the BET specific surface area may refer to the specific surface area measured by the above measurement method.

In the present disclosure, “Dn” refers to a particle diameter distribution, and refers to a particle diameter at the n % point in the cumulative distribution of the number of particles according to the particle diameter. That is, D50 is a particle diameter (average particle diameter, center particle diameter) at the 50% point in the cumulative distribution of the number of particles according to the particle diameter, D90 is a particle diameter at the 90% point in the cumulative distribution of the number of particles according to the particle diameter, and D10 is a particle diameter at the 10% point in the cumulative distribution of the number of particles according to the particle diameter. Meanwhile, the particle diameter distribution may be measured using a laser diffraction method. Specifically, after powder to be measured is dispersed in a dispersion medium, the resultant dispersion is introduced into a commercially available laser diffraction particle diameter measurement apparatus (for example, Microtrac S3500) in which a difference in a diffraction pattern according to the particle size is measured, when a laser beam passes through particles, and then a particle diameter distribution is calculated.

In the present disclosure, the description “a polymer includes a certain monomer as a monomer unit” means that the monomer participates in a polymerization reaction and is included as a repeating unit in the polymer. In the present disclosure, when a polymer includes a monomer, this is interpreted as the same as that the polymer includes a monomer as a monomer unit.

In the present disclosure, it is understood that the term ‘polymer’ is used in a broad sense including a copolymer unless otherwise specified as ‘a homopolymer’.

In the present disclosure, a weight-average molecular weight (Mw) and a number-average molecular weight (Mn) are polystyrene converted molecular weights measured by gel permeation chromatography (GPC) while employing, as a standard material, a monodispersed polystyrene polymer (standard sample) having various degrees of polymerization commercially available for measuring a molecular weight. In the present disclosure, a molecular weight refers to a weight-average molecular weight unless particularly described otherwise.

Hereinafter, embodiments of the present disclosure will be described in detail with reference to the drawings so that one skilled in the art can readily implement the present disclosure. However, the present disclosure may be embodied in various different forms, and is not limited to the following descriptions.

An exemplary embodiment of the present disclosure provides a negative electrode for a lithium secondary battery, the negative electrode including: a negative electrode current collector layer; a first negative electrode active material layer provided on a surface (or both surfaces) of the negative electrode current collector layer; and a second negative electrode active material layer provided on a surface of the first negative electrode active material layer opposite to a surface of the first negative electrode active material layer facing the negative electrode current collector layer, wherein the first negative electrode active material layer includes a first negative electrode active material layer composition including a first negative electrode active material, and the second negative electrode active material layer includes a second negative electrode active material layer composition including a second negative electrode active material, wherein the first negative electrode active material includes one or more selected from the group consisting of Six (x=0) and SiOx (0<x<2), and includes SiOx (x=0) in an amount of 95 parts by weight or more based on 100 parts by weight of the first negative electrode active material, wherein the second negative electrode active material includes a mixture of one or more selected from the group consisting of a carbon-based active material, a silicon-based active material, a metal-based active material capable of alloying with lithium, and a lithium-containing nitride, wherein the second negative electrode active material layer has a first surface and a second surface, and wherein the second surface of the second negative electrode active material layer is facing the first negative electrode active material layer, and the first surface of the second negative electrode active material layer is opposite to the second surface, wherein the first surface and the second surface each include a non-uniform surface, respectively, and wherein the second negative electrode active material layer satisfies a non-uniformity criteria expressed by Formula 1 below:

$$0 μm \leq \vert C - ( A + B / 2 ) \vert \leq 10 μm \qquad Formula 1$$

in the Formula 1,
A refers to a longest distance (μm) between the first surface and the second surface,
B refers to a shortest distance (μm) between the first surface and the second surface, and
C refers to an average thickness (μm) of the second negative electrode active material layer.

In the negative electrode for a lithium secondary battery according to aspects of the present disclosure, the second negative electrode active material layer satisfies the non-uniformity criteria of Formula 1 above. In other words, according to certain aspects, the first negative electrode active material layer has a silicon-based negative electrode and is coated within a thin thickness range. In this case, a problem can arise in forming the second negative electrode active material layer as a thin film on top of the silicon-based negative electrode. However, when performing coating by the method according to aspects of the present disclosure (by controlling a liquid thickness and a core thickness of the coating composition), the non-uniformity criteria of Formula 1 above is satisfied, and the second negative electrode active material layer can be coated more uniformly and thinly on top of the first negative electrode active material layer. In other words, the negative electrode for a lithium secondary battery according to aspects of the present disclosure optimizes uniformities and thicknesses of the first negative electrode active material layer having a high capacity feature and the second negative electrode active material layer capable of controlling the problem of reaction non-uniformity in which a reaction is concentrated only on a surface of an electrode during charging and discharging of the first negative electrode active material layer and the problem of uniformity during pre-lithiation and having excellent durability. Accordingly, a lithium secondary battery including the negative electrode can satisfy optimal capacity characteristics, which are the advantage of a Si negative electrode, and at the same time, can satisfy life characteristics.

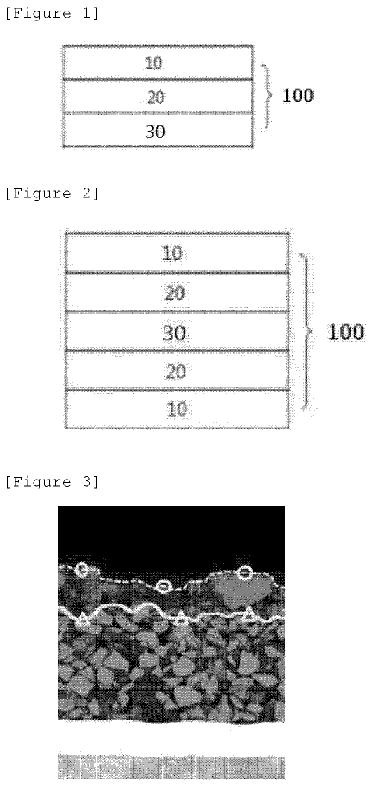

FIG. 1 is a view showing a stack structure of a negative electrode for a lithium secondary battery according to an exemplary embodiment of the present disclosure. Specifically, a negative electrode 100 for a lithium secondary battery can be seen which includes a first negative electrode active material layer 20 and a second negative electrode active material layer 10 on one surface 32 of a negative electrode current collector layer 30. FIG. 1 shows that the first negative electrode active material layer is formed on one surface, but the first negative electrode active material layer may also be formed on both surfaces of the negative electrode current collector layer, according to certain aspects. As described above, in an exemplary embodiment of the present disclosure, the first negative electrode active material layer may be formed on an entire surface of the negative electrode current collector layer, and the second negative electrode active material layer may be formed on an entire surface of the first negative electrode active material layer.

In addition, FIG. 2 is a view showing a stack structure of a negative electrode for a lithium secondary battery according to an exemplary embodiment of the present disclosure. Specifically, as shown in FIG. 2, a first negative electrode active material layer 20 and a second negative electrode active material layer 10 may be formed on both surfaces of a negative electrode current collector layer 30. In addition, an arrangement of 10>20>30>20>10 is possible, and furthermore, when the first negative electrode active material layer and the second negative electrode active material layer are sequentially stacked on only one surface of the negative electrode current collector layer, such as 10>20>30>20, 10>20>30>10, 10>20>30>10>20, or the like, the negative electrode active material layers may be stacked in an arbitrary arrangement on the opposite surface. Preferably, both surfaces of the negative electrode current collector layer have the same composition, and specifically may have a structure of 10>20>30>20>10.

Below, the negative electrode for a lithium secondary battery according to aspects of the present disclosure will be described in more detail.

In an exemplary embodiment of the present disclosure, there is provided a negative electrode for a lithium secondary battery including: a negative electrode current collector layer 30; a first negative electrode active material layer 20 provided on a surface 32 (or both surfaces) of the negative electrode current collector layer 30; and a second negative electrode active material layer 10 provided on a surface 36 of the first negative electrode active material layer opposite to a surface 34 of the first negative electrode active material layer in contact with the negative electrode current collector layer 30.

In an exemplary embodiment of the present disclosure, the negative electrode current collector layer generally has a thickness of 1 μm to 100 μm. Such a negative electrode current collector layer is not particularly limited as long as it has high conductivity without causing a chemical change in the battery. For example, copper, stainless steel, aluminum, nickel, titanium, fired carbon, copper or stainless steel each surface-treated with carbon, nickel, titanium, silver, or the like, an aluminum-cadmium alloy, or the like may be used. In addition, the negative electrode current collector layer may have microscopic irregularities formed on a surface to enhance a bonding force of the negative electrode active material, and may be used in various forms such as a film, a sheet, a foil, a net, a porous body, a foamed body, or a non-woven fabric body.

In an exemplary embodiment of the present disclosure, a thickness of the negative electrode current collector layer may be 1 μm or greater and 100 μm or less. However, the thickness may be variously modified depending on a type and use of the negative electrode used, and is not limited thereto.

In an exemplary embodiment of the present disclosure, the first negative electrode active material may include one or more selected from the group consisting of SiOx (x=0) and SiOx (0<x<2), and may include the SiOx (x=0) in an amount of 95 parts by weight or more based on 100 parts by weight of the first negative electrode active material.

In an exemplary embodiment of the present disclosure, the first negative electrode active material may include one or more selected from the group consisting of SiOx (x=0) and SiOx (0<x<2), and may include SiOx (x=0) in an amount of 95 parts by weight or more, preferably 97 parts by weight or more, and more preferably 99 parts by weight or more, and 100 parts by weight or less, based on 100 parts by weight of the first negative electrode active material.

In an exemplary embodiment of the present disclosure, pure silicon (Si) particles may be particularly used as the first negative electrode active material. The use of pure silicon (Si) as the first negative electrode active material may mean that, based on total 100 parts by weight of the first negative electrode active material as described above, pure Si particles (SiOx (x=0)) not bound to other particles or elements are included within the above range.

In an exemplary embodiment of the present disclosure, the first negative electrode active material may be composed of SiOx (x=0).

The first negative electrode active material layer according to aspects of the present disclosure includes the first negative electrode active material, and specifically, includes pure silicon particles including 95 parts by weight or more of SiOx (x=0). According to certain aspects, when a high content of pure silicon particles is included, the capacity characteristics can be excellent, but the life characteristics can be degraded due to a non-uniform reaction on a surface. Accordingly, in certain embodiments, the second negative electrode active material layer according to aspects of the present disclosure can be included at a specific weight loading amount, thereby solving the above-described problems.

Note that an average particle diameter (D50) of the first negative electrode active material according to aspects of the present disclosure may be 3 μm to 10 μm, specifically 4 μm to 8 μm, and more specifically 5 μm to 7 μm. According to certain aspects, when the average particle diameter is within the above range, a specific surface area of the particles may be within a suitable range, so that a viscosity of a negative electrode slurry can be formed within an appropriate range. Accordingly, the particles constituting the negative electrode slurry can be smoothly dispersed. In addition, according to certain aspects, when the size of the first negative electrode active material has a value equal to or greater than the lower limit value of the range, a contact area between the silicon particles and the conductive material may be excellent due to the composite made of the conductive material and the binder in the negative electrode slurry, so that a sustaining possibility of the conductive network can increase, thereby increasing the capacity retention rate. In the meantime, according to certain aspects, when the average particle diameter satisfies the above range, excessively large silicon particles can be excluded, so that a smooth surface of the negative electrode can be formed. Accordingly, a current density non-uniformity phenomenon during charging and discharging can be prevented.

In an exemplary embodiment of the present disclosure, the first negative electrode active material generally has a characteristic BET specific surface area. The BET specific surface area of the first negative electrode active material is preferably 0.01 m²/g to 150.0 m²/g, more preferably 0.1 m²/g to 100.0 m²/g, particularly preferably 0.2 m²/g to 80.0 m²/g, and most preferably 0.2 m²/g to 18.0 m²/g. The BET specific surface area is measured in accordance with DIN 66131 (using nitrogen).

In an exemplary embodiment of the present disclosure, the first negative electrode active material may be present, for example, in a crystalline or amorphous form, and is preferably not porous. The silicon particles are preferably spherical or splinter-shaped particles. Alternatively, but less preferably, the silicon particles may also have a fiber structure or may be present in the form of a silicon-containing film or coating.

In an exemplary embodiment of the present disclosure, the first negative electrode active material may have a non-spherical shape and its sphericity (circularity) is, for example, 0.9 or less, for example, 0.7 to 0.9, for example 0.8 to 0.9, and for example 0.85 to 0.9.

According to aspects of the present disclosure, the sphericity is determined by Formula A-1, in which A is an area and P is a boundary line.

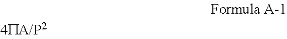

In an exemplary embodiment of the present disclosure, there is provided the negative electrode for the lithium secondary battery in which the first negative electrode active material is included in an amount of 60 parts by weight or more based on 100 parts by weight of the first negative electrode active material layer composition.

In another exemplary embodiment, the first negative electrode active material may be included in an amount of 60 parts by weight or more, preferably 65 parts by weight or more, and more preferably 70 parts by weight or more, and 95 parts by weight or less, preferably 90 parts by weight or less, and more preferably 80 parts by weight or less based on 100 parts by weight of the first negative electrode active material layer composition.

Although the first negative electrode active material layer composition according to aspects of the present disclosure uses the first negative electrode active material with a significantly high capacity within the above range, the first negative electrode active material layer composition can also uses a second negative electrode active material layer described below, thereby at least partly addressing and even solving the problems of surface degradation during charging and discharging, uniformity during pre-lithiation, and life characteristics without lowering the overall capacity performance of the negative electrode.

In the related art, it is typical to use only graphite-based compounds as the negative electrode active material. However, in recent years, as the demand for high-capacity batteries is increasing, attempts to mix and use silicon-based compounds have been increasing in order to increase capacity. However, the silicon-based compounds have limitations in that the volume rapidly expands during the charging/discharging, which can result in damage to the conductive path formed in the negative electrode active material layer to degrade the performance of the battery.

Accordingly, in an exemplary embodiment of the present disclosure, the first negative electrode active material layer composition may further include one or more selected from the group consisting of a first negative electrode conductive material, and a first negative electrode binder.

In this case, as the first negative electrode conductive material and the first negative electrode binder included in the first negative electrode active material layer composition, those used in the art may be used without limitation.

In an exemplary embodiment of the present disclosure, as the first negative electrode conductive material, materials that can be generally used in the art may be used without limitation, and specifically, one or more selected from the group consisting of a point-like conductive material, a planar conductive material; and a linear conductive material may be included.

In an exemplary embodiment of the present disclosure, the point-like conductive material refers to a conductive material that may be used for improving conductivity of the negative electrode, has conductivity without causing a chemical change and has a point-like or spherical shape. Specifically, the point-like conductive material may be one or more species selected from the group consisting of natural graphite, artificial graphite, carbon black, acetylene black, Ketjen black, channel black, furnace black, lamp black, thermal black, conductive fiber, fluorocarbon, aluminum powder, nickel powder, zinc oxide, potassium titanate, titanium oxide, and a polyphenylene derivative, and preferably may include carbon black in terms of high conductivity and excellent dispersibility.

In an exemplary embodiment of the present disclosure, the point-like conductive material may have a BET specific surface area of 40 m²/g or greater and 70 m²/g or less, preferably 45 m²/g or greater and 65 m²/g or less, and more preferably 50 m²/g or greater and 60 m²/g or less.

In an exemplary embodiment of the present disclosure, a particle diameter of the point-like conductive material may be 10 nm to 100 nm, preferably 20 nm to 90 nm, and more preferably 20 nm to 60 nm.

In an exemplary embodiment of the present disclosure, the first negative electrode conductive material may include a planar conductive material.

The planar conductive material can serve to improve conductivity by increasing surface contact between silicon particles in the negative electrode, and at the same time, to suppress the disconnection of the conductive path due to the volume expansion, and may be expressed as a plate-like conductive material or a bulk-type conductive material.

In an exemplary embodiment of the present disclosure, the planar conductive material may include one or more selected from the group consisting of plate-like graphite, graphene, graphene oxide, and graphite flake, and preferably may be plate-like graphite.

In an exemplary embodiment of the present disclosure, the average particle diameter (D50) of the planar conductive material may be 2 μm to 7 μm, specifically 3 μm to 6 μm, and more specifically 4 μm to 5 μm. According to certain embodiments, when the above range is satisfied, the sufficient particle size can result in easy dispersion without causing an excessive increase in viscosity of the negative electrode slurry. Therefore, the dispersion effect may be excellent when dispersing using the same equipment and time.

In an exemplary embodiment of the present disclosure, there is provided the negative electrode composition in which the planar conductive material has D10 of 0.5 μm or greater and 1.5 μm or less, D50 of 2.5 μm or greater and 3.5 μm or less, and D90 of 7.0 μm or greater and 15.0 μm or less.

In an exemplary embodiment of the present disclosure, for the planar conductive material, a planar conductive material with a high specific surface area having a high BET specific surface area or a planar conductive material with a low specific surface area may be used.

In an exemplary embodiment of the present disclosure, for the planar conductive material, a planar conductive material with a high specific surface area or a planar conductive material with a low specific surface area may be used without limitation. However, in particular, the planar conductive material according to aspects of the present disclosure can be affected to some extent in the electrode performance by the dispersion effect, so that a planar conductive material with a low specific surface area that does not cause a problem in dispersion is used particularly preferably.

In an exemplary embodiment of the present disclosure, the planar conductive material may have a BET specific surface area of 5 m²/g or greater.

In another exemplary embodiment, the planar conductive material may have a BET specific surface area of 5 m²/g or greater and 500 m²/g or less, preferably 5 m²/g or greater and 300 m²/g or less, and more preferably 5 m²/g or greater and 250 m²/g or less.

In another exemplary embodiment, the planar conductive material is a planar conductive material with a high specific surface area, and the BET specific surface area may satisfy a range of 50 m²/g or greater and 500 m²/g or less, preferably 80 m²/g or greater and 300 m²/g or less, and more preferably 100 m²/g or greater and 300 m²/g or less.

In another exemplary embodiment, the planar conductive material is a planar conductive material with a low specific surface area, and the BET specific surface area may satisfy a range of 5 m²/g or greater and 40 m²/g or less, preferably 5 m²/g or greater and 30 m²/g or less, and more preferably 5 m²/g or greater and 25 m²/g or less.

Other conductive materials may include linear conductive materials such as carbon nanotubes. The carbon nanotubes may be bundle-type carbon nanotubes. The bundle-type carbon nanotubes may include a plurality of carbon nanotube units. Specifically, the term ‘bundle type’ herein refers to, unless otherwise specified, a bundle or rope-shaped secondary shape in which a plurality of carbon nanotube units are aligned side by side in such an orientation that longitudinal axes of the carbon nanotube units are substantially the same, or are entangled. The carbon nanotube unit has a graphite sheet having a cylindrical shape with a nano-sized diameter, and has an sp2 bonding structure. In this case, the characteristics of a conductor or a semiconductor may be exhibited depending on the rolled angle and structure of the graphite sheet. As compared with entangled-type carbon nanotubes, the bundle-type carbon nanotubes can be more uniformly dispersed during the manufacture of the negative electrode, and can form more smoothly a conductive network in the negative electrode to improve the conductivity of the negative electrode.

In an exemplary embodiment of the present disclosure, the first negative electrode conductive material may satisfy a range of 10 part by weight or more and 40 parts by weight or less, based on 100 parts by weight of the first negative electrode active material layer composition.

In another exemplary embodiment, the first negative electrode conductive material may be included in an amount of 1 part by weight or more and 40 parts by weight or less, preferably 3 parts by weight or more and 30 parts by weight or less, and more preferably 5 parts by weight or more and 25 parts by weight or less based on 100 parts by weight of the first negative electrode active material layer composition.

In an exemplary embodiment of the present disclosure, the first negative electrode conductive material may include a point-like conductive material, a planar conductive material, and a linear conductive material, and a ratio of the point-like conductive material: the planar conductive material: the linear conductive material may satisfy 1:1:0.01 to 1:1:1.

In an exemplary embodiment of the present disclosure, the point-like conductive material may satisfy a range of 1 part by weight or more and 60 parts by weight or less, preferably 5 parts by weight or more and 50 parts by weight or less, and more preferably 10 parts by weight or more and 50 parts by weight or less based on 100 parts by weight of the first negative electrode conductive material.

In an exemplary embodiment of the present disclosure, the planar conductive material may satisfy a range of 1 part by weight or more and 60 parts by weight or less, preferably 5 parts by weight or more and 50 parts by weight or less, and more preferably 10 parts by weight or more and 50 parts by weight or less based on 100 parts by weight of the first negative electrode conductive material.

In an exemplary embodiment of the present disclosure, the linear conductive material may satisfy a range of 0.01 part by weight or more and 10 parts by weight or less, preferably 0.05 part by weight or more and 8 parts by weight or less, and more preferably 0.1 part by weight or more and 5 parts by weight or less, based on 100 parts by weight of the first negative electrode conductive material.

In an exemplary embodiment of the present disclosure, the first negative electrode conductive material may include a linear conductive material, and a planar conductive material.

In an exemplary embodiment of the present disclosure, the first negative electrode conductive material may include a linear conductive material and a planar conductive material, and a weight ratio of the linear conductive material to the planar conductive material may satisfy 0.01:1 to 0.1:1.

In an exemplary embodiment of the present disclosure, as the first negative electrode conductive material satisfies the composition and ratio described above, the first negative electrode conductive material has a feature in which output characteristics at high C-rate are excellent because the life characteristics of the existing lithium secondary battery are not greatly affected and points where the battery can be charged and discharged are increased.

The first negative electrode conductive material according to aspects of the present disclosure has a completely different configuration from a conductive material that is applied to the positive electrode. That is, the first negative electrode conductive material according to aspects of the present disclosure serves to hold contacts between silicon-based active materials whose volume expansion of the electrode is very large due to charging and discharging, and the positive electrode conductive material serves to impart some conductivity while serving as a buffer when roll-pressed, and is completely different from the negative electrode conductive material according to aspects of the present disclosure in terms of configuration and role.

In addition, the first negative electrode conductive material according to aspects of the present disclosure is applied to a silicon-based active material, and has a completely different configuration from that of a conductive material that is applied to a graphite-based active material. That is, since a conductive material that is used for an electrode having a graphite-based active material simply has smaller particles than the active material, the conductive material has characteristics of improving output characteristics and imparting some conductivity, and is completely different from the first negative electrode conductive material that is applied together with the silicon-based active material according to aspects of in the present disclosure, in terms of configuration and role.

In an exemplary embodiment of the present disclosure, the first negative electrode binder may include at least one selected from the group consisting of polyvinylidenefluoride-hexafluoropropylene copolymer (PVDF-CO-HFP), polyvinylidenefluoride, polyacrylonitrile, polymethylmethacrylate, polyvinyl alcohol, carboxymethylcellulose (CMC), starch, hydroxypropylcellulose, regenerated cellulose, polyvinylpyrrolidone, polytetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-mentioned materials in which a hydrogen is substituted with Li, Na, Ca, etc., and may also include various copolymers thereof.

The first negative electrode binder according to an exemplary embodiment of the present disclosure serves to hold the first negative electrode active material and the first negative electrode conductive material in order to prevent distortion and structural deformation of the negative electrode structure in volume expansion and relaxation of the first negative electrode active material. When such roles are satisfied, all of the general binders can be applied. Specifically, an aqueous binder may be used, and more specifically, a PAM-based binder may be used.

In an exemplary embodiment of the present disclosure, the first negative electrode binder may be included in an amount of 30 parts by weight or less, preferably 25 parts by weight or less, and more preferably 20 parts by weight or less, and 5 parts by weight or more and 10 parts by weight or more based on 100 parts by weight of the first negative electrode active material layer composition.

Compared to existing carbon-based negative electrodes, when a Si-based negative electrode is used, an aqueous binder is applied in parts by weight described above, allowing the use of a point-like conductive material. In addition, the above characteristics allows the point-like conductive material to have hydrophobicity and excellent bond strength between the conductive material and the binder.

In an exemplary embodiment of the present disclosure, wherein the second negative electrode active material may include a mixture of one or more selected from the group consisting of a carbon-based active material, a silicon-based active material, a metal-based active material capable of alloying with lithium, and a lithium-containing nitride.

In another exemplary embodiment, the second negative electrode active material may include a mixture of one or more and three or less selected from the group consisting of a carbon-based active material, a silicon-based active material, a metal-based active material capable of alloying with lithium, and a lithium-containing nitride.

In another exemplary embodiment, the second negative electrode active material may include a carbon-based active material and a silicon-based active material.

In another exemplary embodiment, the second negative electrode active material may include a silicon-based active material.

In an exemplary embodiment of the present disclosure, there is provided the negative electrode for the lithium secondary battery in which the second negative electrode active material includes a mixture of one or more selected from the group consisting of a carbon-based active material, a silicon-based active material, a metal-based active material capable of alloying with lithium, and a lithium-containing nitride, and the silicon-based active material is included in an amount of 50 parts by weight or more and 100 parts by weight or less based on 100 parts by weight of the second negative electrode active material.

In another exemplary embodiment, the second negative electrode active material may include a mixture of one or more selected from the group consisting of a carbon-based active material, a silicon-based active material, a metal-based active material capable of alloying with lithium, and a lithium-containing nitride, and the silicon-based active material may be included in an amount of 50 parts by weight or more and 100 parts by weight or less, preferably 70 parts by weight or more and 100 parts by weight or less, and more preferably 80 parts by weight or more and 100 parts by weight or less based on 100 parts by weight of the second negative electrode active material.

In an exemplary embodiment of the present disclosure, the silicon-based active material included in the second negative electrode active material may include one or more selected from the group consisting of Siox (0<x<2), siC, and a Si alloy.

In an exemplary embodiment of the present disclosure, the silicon-based active material included in the second negative electrode active material may include one or more selected from the group consisting of Siox (0<x<2), siC, and a Si alloy, and may include SiOx (0<x<2) in an amount of 1 part by weight or more based on 100 parts by weight of the second negative electrode active material.

In another exemplary embodiment, the silicon-based active material included in the second negative electrode active material may include one or more selected from the group consisting of SiOx (0<x<2), SiC, and a Si alloy, and may include SiOx (0<x<2) in an amount of 1 part by weight or more, or 10 parts by weight or more, and 99 parts by weight or less based on 100 parts by weight of the second negative electrode active material.

In another exemplary embodiment, the silicon-based active material included in the second negative electrode active material may include SiOx (0<x<2).

In another exemplary embodiment, the silicon-based active material included in the second negative electrode active material may include SiC.

The negative electrode for a lithium secondary battery according to aspects of the present disclosure includes the second negative electrode active material in the second negative electrode active material layer as described above. Accordingly, in certain embodiments, while maintaining the high capacity and high density characteristics by including the above-described first negative electrode active material, the second negative electrode active material can serve as a buffer layer, making it possible to address the problem of degradation in surface during charging and discharging, the problem of uniformity during pre-lithiation, and the problem of life characteristics.

As an example, the second negative electrode active material layer according to aspects of the present disclosure may function as a buffer layer. An electrode containing a Si active material has excellent capacity characteristics compared to electrodes containing Sio or carbon-based active material. However, in the electrode containing a Si active material, deterioration may be concentrated on the surface of the negative electrode active material layer due to rapid reaction with Li ions during charging and discharging. This may also occur during the pre-lithiation process in which lithium ions are included in advance in the negative electrode active material layer. According to certain aspects, in the pre-lithiation process, a buffer layer can be used to prevent direct contact between a Si-based electrode and lithium and to prevent deterioration in surface. Therefore, the second negative electrode active material layer according to aspects of the present disclosure may have the feature of being able to exhibit the same role and effect as the buffer layer in the pre-lithiation process.

In an exemplary embodiment of the present disclosure, representative examples of the carbon-based active material include natural graphite, artificial graphite, expandable graphite, carbon fiber, non-graphitizable carbon, carbon black, carbon nanotubes, fullerene, activated carbon, or the like, and the carbon-based active material can be used without limitation as long as the carbon-based active material is typically used in a carbon material for a lithium secondary battery, and specifically may be processed into a spherical or point-like shape and used.

In an exemplary embodiment of the present disclosure, the planar conductive material that is used as the first negative electrode conductive material described above has different structure and role from those of the carbon-based active material that is generally used as the negative electrode active material. Specifically, the carbon-based active material that is used as the negative electrode active material may be artificial graphite or natural graphite, and refers to a material that is processed into a spherical or point-like shape and used so as to facilitate storage and release of lithium ions.

On the other hand, the planar conductive material that is used as the first negative electrode conductive material is a material having a plane or plate-like shape, and may be expressed as plate-like graphite. That is, the planar conductive material is a material that is included so as to maintain a conductive path in the negative electrode active material layer, and refers to a material for securing a conductive path in a planar shape inside the negative electrode active material layer, rather than playing a role in storing and releasing lithium.

That is, in the present disclosure, the use of plate-like graphite as a conductive material means that graphite is processed into a planar or plate-like shape and used as a material for securing a conductive path rather than playing a role in storing or releasing lithium. In this case, the negative electrode active material included together has high-capacity characteristics with respect to storing and releasing lithium, and serves to store and release all lithium ions transferred from the positive electrode.

On the other hand, in the present disclosure, the use of a carbon-based active material as an active material means that the carbon-based active material is processed into a point-like or spherical shape and used as a material for storing or releasing lithium.

That is, in an exemplary embodiment of the present disclosure, artificial graphite or natural graphite, which is a carbon-based active material, may have a BET specific surface area that satisfies a range of 0.1 m²/g or greater and 4.5 m²/g or less. In addition, plate-like graphite, which is a planar conductive material, has a planar shape, and a BET specific surface area thereof may be 5 m²/g or greater.

A representative example of the metal-based active material may be a compound containing any one or two or more metal elements selected from the group consisting of Al, Sn, Ag, Bi, Mg, Zn, In, Ge, Pb, Pd, Pt, Ti, Sb, Ga, Mn, Fe, Co, Ni, Cu, Sr, and Ba and the like. These metal compounds may be used in any form such as a single body, an alloy, an oxide (TiO₂, SnO₂ and the like), a nitride, a sulfide, a boride, and an alloy with lithium, but the single body, the alloy, the oxide, and the alloy with lithium may be increased in capacity.

In an exemplary embodiment of the present disclosure, there is provided the negative electrode for a lithium secondary battery in which the second negative electrode active material is included in an amount of 60 parts by weight or more based on 100 parts by weight of the second negative electrode active material layer composition.

In another exemplary embodiment, the second negative electrode active material may be included in an amount of 60 parts by weight or more, and 100 parts by weight or less, or 99 parts by weight or less based on 100 parts by weight of the second negative electrode active material layer composition.

The second negative electrode active material layer composition according to aspects of the present disclosure may have a feature of suppressing a surface reaction of the negative electrode to enhance life characteristics without deteriorating the capacity performance of the negative electrode by using the second negative electrode active material within the above range, which may have lower capacity characteristics but may also have less particle cracking during charging and discharging than the first negative electrode active material.

In an exemplary embodiment of the present disclosure, there is provided the negative electrode for the lithium secondary battery in which the second negative electrode active material layer composition further includes one or more selected from the group consisting of a second negative electrode conductive material and a second negative electrode binder.

In this case, the descriptions regarding the second negative electrode conductive material and the second negative electrode binder may be the same as the above descriptions regarding the first negative electrode conductive material and the first negative electrode binder.

In an exemplary embodiment of the present disclosure, the second negative electrode active material layer 10 has a first surface 40 and a second surface 38, wherein the second surface 38 of the second negative electrode active material layer 10 is facing the first negative electrode active material layer 20, and the first surface 40 of the second negative electrode active material layer is opposite to the second surface 38, and the first surface and the second surface each include a non-uniform surface, respectively.

In this case, according to certain aspects, the fact that the first surface and the second surfaces include a non-uniform surface, respectively, means that a surface or interface is not formed ideally straight without irregularities, but includes some irregularities and curves.

That is, in general, when a composition is coated, a surface or interface thereof is not formed ideally straight but is formed to have a bumpy shape, which can be interpreted to mean that the first surface and the second surface include non-uniform surfaces.

FIG. 3 is a view showing a SEM photograph of a negative electrode for a lithium secondary battery according to an exemplary embodiment of the present disclosure. Specifically, a surface marked with a dotted line (triangle mark) corresponds to the second surface of the second negative electrode active material layer, and a surface marked with a dotted line (circle mark) corresponds to the first surface. In this case, including a non-uniform surface may mean that the triangle mark and circle mark dotted lines do not form straight lines but include curves.

In an exemplary embodiment of the present disclosure, there is provided the negative electrode for the lithium secondary battery in which the second negative electrode active material layer satisfies a non-uniformity criteria expressed by Formula 1 below.

$$0 μm \leq \vert C - ( A + B / 2 ) \vert \leq 10 μm \qquad Formula 1$$

in the Formula 1,
A refers to a longest distance (μm) between the first surface and the second surface,
B refers to a shortest distance (μm) between the first surface and the second surface, and
C refers to an average thickness (μm) of the second negative electrode active material layer.

In an exemplary embodiment of the present disclosure, A refers to the longest distance (μm) between the first surface and the second surface. Specifically, A may refer to the longest distance among all vertical distances in a thickness direction between the first surface and the second surface.

In an exemplary embodiment of the present disclosure, B refers to the shortest distance (μm) between the first surface and the second surface. Specifically, B may refer to the shortest distance among all vertical distances in the thickness direction between the first surface and the second surface.

In addition, C is a value measured by averaging all vertical distances in the thickness direction between the first and second surfaces, and is defined as an average thickness of the second negative electrode active material layer.

According to certain aspects, in the present disclosure, when the first negative electrode active material layer and the second negative electrode active material layer are ideally coated, both the first surface and the second surface are formed as uniform surfaces, and the values of A and B may be the same. That is, it may mean that the first surface and the second surface are formed uniformly in such a form that both the shortest distance and the longest distance are the same. In this case, if both the first negative electrode active material layer and the second negative electrode active material layer are uniformly coated, the shortest distance, the longest distance, and the average thickness of the second negative electrode active material layer all have the same value, and Formula 1 above satisfies the value of 0.

In an exemplary embodiment of the present disclosure, the fact that the second negative electrode active material layer satisfies the range of Formula 1 above may mean that the second negative electrode active material layer is more uniformly coated on top of the first negative electrode active material layer.

In an exemplary embodiment of the present disclosure, Formula 1 above may satisfy 0 μm≤|C−(A+B/2)|≤10 μm, preferably 0.5 μm≤|C−(A+B/2)|≤8 μm, and more preferably 0.5 μm≤|C−(A+B/2)|≤5 μm.

In an exemplary embodiment of the present disclosure, there is provided the negative electrode for a lithium secondary battery in which A is 5 μm or greater and 25 μm or less and C is 5 μm or greater and 20 μm or less.

In an exemplary embodiment of the present disclosure, A may satisfy a range of 5 μm or greater and 25 μm or less, preferably 5.5 μm or greater and 20 μm or less, and more preferably 6 μm or greater and 19 μm or less.

In an exemplary embodiment of the present disclosure, B may satisfy a range of 3 μm or greater and 10 μm or less, preferably 4 μm or greater and 9 μm or less, and more preferably 7 μm or greater and 9 μm or less.

In an exemplary embodiment of the present disclosure, C may satisfy a range of 5 μm or greater and 20 μm or less, preferably 5.5 μm or greater and 18 μm or less, and more preferably 6 μm or greater and 15 μm or less.

Particularly, in the negative electrode for a lithium secondary battery according to aspects of the present disclosure, the second negative electrode active material layer satisfies the non-uniformity criteria of Formula 1 above. In other words, according to certain aspects, the first negative electrode active material layer has a silicon-based negative electrode and is coated within a thin thickness range. In this case, a problem arises in forming the second negative electrode active material layer as a thin film on top of the silicon-based negative electrode. However, according to certain aspects, when performing coating by a method described below (by controlling a liquid thickness and a core thickness of a coating composition), the non-uniformity criteria of Formula 1 above can be satisfied, and the second negative electrode active material layer can be coated more uniformly and thinly on top of the first negative electrode active material layer. Accordingly, it is possible to secure rapid charging performance, and at the same time, to secure lifespan characteristics by effectively controlling a surface deterioration reaction.

In an exemplary embodiment of the present disclosure, there is provided the negative electrode for the lithium secondary battery in which the average thickness of the second negative electrode active material layer is 10% or greater and 40% or less of a total thickness of the first negative electrode active material layer and the second negative electrode active material layer.

In another exemplary embodiment, the thickness of the first negative electrode active material layer may be 10 μm or greater and 200 μm or less, specifically 15 μm or greater and 190 μm or less, and more specifically 20 μm or greater and 170 μm or less.

In an exemplary embodiment of the present disclosure, there is provided the negative electrode for the lithium secondary battery in which an average surface roughness (Sa) of the first surface is 700 nm or less.

In another exemplary embodiment, the average surface roughness (Sa) of the first surface may be 700 nm or less, preferably 680 nm or less, more preferably 660 nm or less, and 400 nm or greater, preferably 500 nm or greater, and more preferably 600 nm or greater.

In an exemplary embodiment of the present disclosure, the average surface roughness may refer to a surface roughness. The average surface roughness indicates a degree of roughness of a surface and may indicate a degree of unevenness of a surface of a target material.

In an exemplary embodiment of the present disclosure, there is provided the negative electrode for the lithium secondary battery in which a viscosity of the first negative electrode active material layer composition is a shear viscosity of 2,000 cPs or higher and 15,000 cPs or less at a shear rate of 2.5 (1/s), and a viscosity of the second negative electrode active material layer composition is lower than the viscosity of the first negative electrode active material layer composition.

In another exemplary embodiment, the viscosity of the first negative electrode active material layer composition may satisfy a shear viscosity of 2,000 cPs or higher and 15,000 cPs or less, preferably 2, 300 cPs or higher and 14,000 cPs or less, and more preferably 2,500 cPs or higher and 12,000 cPs or less at a shear rate of 2.5 (1/s).

In this case, according to certain aspects, the viscosity of the second negative electrode active material layer composition may be be maintained lower than the viscosity of the first negative electrode active material layer composition so that a two-layered negative electrode active material layer can be formed as in aspects of the present disclosure. More specifically, according to certain aspects, the viscosity of the second negative electrode active material layer composition should be lower than but similar to the viscosity of the first negative electrode active material layer composition.

In an exemplary embodiment of the present disclosure, the negative electrode for a lithium secondary battery may be pre-lithiated.

The negative electrode for a lithium secondary battery according to aspects of the present disclosure is composed of a double layer, and in particular, the second negative electrode active material layer that satisfies a specific non-uniformity criteria can serve as a buffer layer during pre-lithiation, allowing uniform lithiation to occur in an electrode depth direction during charging and discharging cycles.

An exemplary embodiment of the present disclosure provides a method for manufacturing a negative electrode for a lithium secondary battery, the method including: preparing a negative electrode current collector layer; forming a first negative electrode active material layer by applying a first negative electrode active material layer composition to a surface (or both surfaces) of the negative electrode current collector layer using a first coating composition; and forming a second negative electrode active material layer by applying a second negative electrode active material layer composition to a surface of the first negative electrode active material layer opposite to a surface of the first negative electrode active material layer that is in contact with the negative electrode current collector layer using a second coating composition, wherein the first negative electrode active material includes one or more selected from the group consisting of SiOx (x=0) and SiOx (0<x<2), and includes SiOx (x=0) in an amount of 95 parts by weight or more based on 100 parts by weight of the first negative electrode active material, wherein the second negative electrode active material includes a mixture of one or more selected from the group consisting of a carbon-based active material, a silicon-based active material, a metal-based active material capable of alloying with lithium, and a lithium-containing nitride, wherein in the step of forming the first negative electrode active material layer by applying the first negative electrode active material layer composition, a liquid thickness of the first coating composition is 50 μm or greater and 100 μm or less, and wherein in the step of forming the second negative electrode active material layer by applying the second negative electrode active material layer composition to the surface of the first negative electrode active material layer opposite to the surface of the first negative electrode active material layer that is in contact with the negative electrode current collector layer, a liquid thickness of the second coating composition is 10 μm or greater and 60 μm or less.

In the method for manufacturing a negative electrode, the above-described descriptions may be applied to the composition and content included in each step.

That is, according to certain aspects, each composition can be applied through a coating composition in order to form the first negative electrode active material layer and the second negative electrode active material layer as described above. In this case, according to certain aspects, it was found that when the liquid thickness of the coating composition as described above is satisfied, the second negative electrode active material layer can be applied thinly and uniformly in the form of a thin film on the top of the first negative electrode active material layer. Accordingly, the negative electrode for a lithium secondary battery satisfying Formula 1 above can be manufactured.

In an exemplary embodiment of the present disclosure, the liquid thickness of the coating composition may have the same meaning as a thickness of a coating liquid, and may mean a liquid thickness of the coated first negative electrode active material layer composition or second negative electrode active material layer composition itself.

In an exemplary embodiment of the present disclosure, there is the method of manufacturing a negative electrode for a lithium secondary battery in which a core thickness of the coating composition is 0.4 T or greater and 2 T or less.

Aspects of the present disclosure apply the second negative electrode active material layer, which can take the advantage of a pure Si active material and address the disadvantages, to the first negative electrode active material layer. In particular, according to certain aspects, the second negative electrode active material layer should be implemented as a thin film coating. However, according to certain aspects, it can be a difficult task to coat the second negative electrode active material layer thinly and uniformly on top of the thin first negative electrode active material layer. However, according to certain aspects, it was found that when the liquid thickness and core thickness of the coating composition are adjusted to the above-described ranges, as described above, a negative electrode for a lithium secondary battery satisfying the uniformity and thickness according to aspects of the present disclosure can be manufactured.

An exemplary embodiment of the present disclosure includes forming a first negative electrode active material layer by applying a first negative electrode active material layer composition on one surface or both surfaces of the negative electrode current collector layer using a first coating composition.

That is, according to certain aspects, this step is a step of forming an active material layer on the negative electrode current collector layer, and may mean a step of forming an active material layer on a surface (lower layer part), which is in contact with the negative electrode current collector layer, of a double layer structure.

In an exemplary embodiment of the present disclosure, applying the first negative electrode active material layer composition includes applying and drying a first negative electrode slurry including a first negative electrode active material layer composition and a negative electrode slurry solvent.

In this case, according to certain aspects, a solid content of the first negative electrode slurry may satisfy a range of 10% to 40%.

In an exemplary embodiment of the present disclosure, the forming of the first negative electrode active material layer may include mixing the first negative electrode slurry; and coating the mixed first negative electrode slurry on one surface or both surfaces of the negative electrode current collector layer using a first coating composition, and the coating may be performed using a coating method that is commonly used in the art.

An exemplary embodiment of the present disclosure includes forming a second negative electrode active material by applying a second negative electrode active material layer composition to a surface of the first negative electrode active material layer opposite to a surface in contact with the negative electrode current collector layer using a second coating composition.

That is, according to certain aspects, this step may be a step of forming a second negative electrode active material layer on the first negative electrode active material layer, and may mean a step of forming an active material layer on a surface (upper layer part), which is apart from the negative electrode current collector layer, of the double layer structure.

In an exemplary embodiment of the present disclosure, the applying of the second negative electrode active material layer composition includes applying and drying a second negative electrode slurry including a second negative electrode active material layer composition and a negative electrode slurry solvent.

In this case, according to certain aspects, a solid content of the second negative electrode slurry may satisfy a range of 10% to 40%.

In an exemplary embodiment of the present disclosure, there is provided a method for manufacturing the negative electrode for the lithium secondary battery in which the forming of the second negative electrode active material layer may include mixing the second negative electrode slurry, and coating the mixed second negative electrode slurry on a surface opposite to a surface of the first negative electrode active material layer in contact with the negative electrode current collector layer.

The coating may be performed using a coating method that is commonly used in the art.

According to certain aspects, the description of the forming of the first negative electrode active material layer may be applied to the forming of the second negative electrode active material layer in the same manner.

In an exemplary embodiment of the present disclosure, there is provided a method for manufacturing the negative electrode for the lithium secondary battery in which the forming of the second negative electrode active material layer on the first negative electrode active material layer may include a wet on dry process, or a wet on wet process.

In an exemplary embodiment of the present disclosure, the wet on dry process may refer to a process of applying the first negative electrode active material layer composition, drying the composition partially or completely, and applying the second negative electrode active material layer composition on top of the composition.

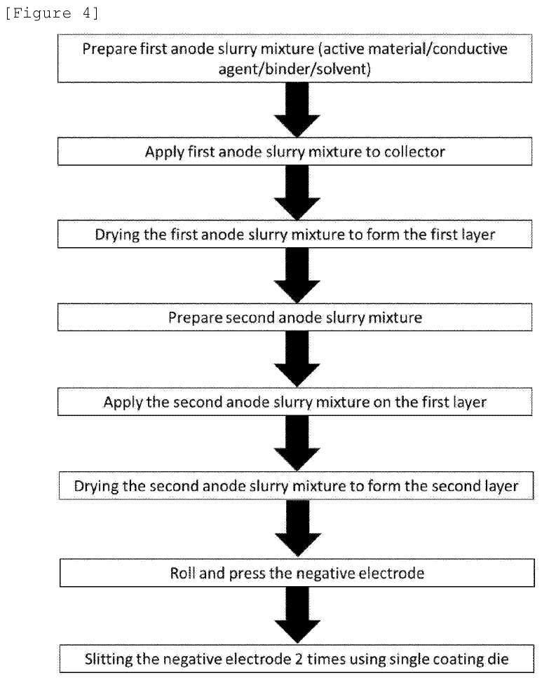

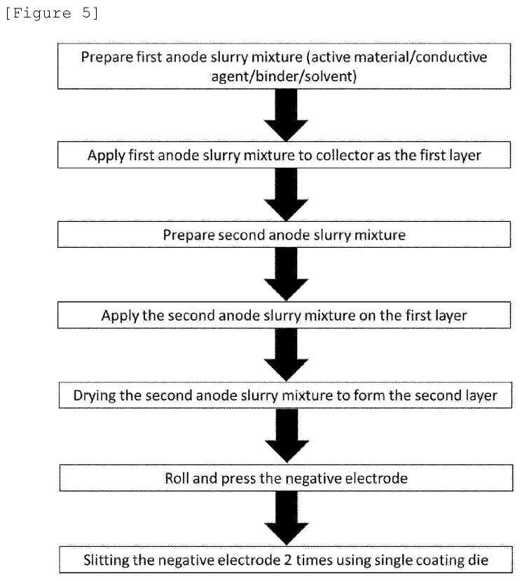

FIG. 4 is a flowchart showing a wet on dry process according to an exemplary embodiment of the present disclosure. Specifically, in the wet on dry process, a first negative electrode slurry mixture (first negative electrode active material, first negative electrode conductive material, first negative electrode binder, first solvent) is prepared and applied to the negative electrode current collector layer. Thereafter, the first negative electrode slurry mixture is dried to form a first negative electrode active material layer. Thereafter, a second negative electrode slurry mixture is prepared, applied to the first negative electrode active material layer, and dried to form a second negative electrode active material layer. Thereafter, each layer may be rolled and pressed to form a negative electrode for a lithium secondary battery according to aspects of the present disclosure.

In an exemplary embodiment of the present disclosure, the wet on wet process refers to a process of applying the first negative electrode active material layer composition and applying the second negative electrode active material layer composition on top of the first negative electrode active material layer composition without drying the same.

FIG. 5 is a flowchart showing a wet on wet process according to an exemplary embodiment of the present disclosure. Specifically, in the wet on wet process, a first negative electrode slurry mixture is prepared and applied to a negative electrode current collector layer, and at the same time, a second negative electrode slurry mixture is prepared and applied to the first negative electrode slurry mixture, and then, the first and second negative electrode slurry mixtures are dried. Thereafter, each layer may be rolled and pressed to form a negative electrode for a lithium secondary battery according to the present disclosure.

Thereafter, according to certain aspects, the negative electrode formed according to the wet on dry process or wet on wet process may be slit twice using a single coating die.

In particular, according to certain aspects, the wet on dry process is performed to apply the first negative electrode active material layer composition, to completely dry the composition, and then to apply the second negative electrode active material layer composition thereon, making it possible for the first negative electrode active material layer and the second negative electrode active material layer to have a clear boundary through the processes as described above. Accordingly, the compositions included in the first negative electrode active material layer and the second negative electrode active material layer are not mixed, making it possible to configure a double layer.

In an exemplary embodiment of the present disclosure, the negative electrode slurry solvent may be used without limitation as long as it can dissolve the first negative electrode active material layer composition and the second negative electrode active material layer composition, and specifically, water or NMP may be used.

According to certain aspects, as a result of the wet on wet process described above, a bonding region in which the first negative electrode active material layer and the second negative electrode active material layer are mixed may be formed. In this case, according to certain aspects, in order for the wet on wet process to occur, the viscosity of the first negative electrode active material layer composition should be lower than the viscosity of the second negative electrode active material layer composition such that inter-mixing can occur in the bonding region and the process.

According to aspects of the present disclosure, after the first negative electrode active material layer is dried (wet on dry process), the second negative electrode active material layer can be formed, so that an interface between the two layers is clearly divided. In addition, when the second negative electrode active material layer is applied in a state in which the first negative electrode active material layer composition is not completely dried (the first negative electrode active material layer composition and the second negative electrode active material layer composition are applied simultaneously), mixing can occur at an interface of the two layers, forming a bonding region.

In an exemplary embodiment of the present disclosure, there is provided a method for manufacturing the negative electrode for the lithium secondary battery, the method including pre-lithiating a negative electrode in which the first negative electrode active material layer and the second negative electrode active material layer are formed on the negative electrode current collector layer, wherein the pre-lithiating of the negative electrode includes a lithium electroplating process, a lithium metal transfer process, a lithium metal deposition process, or a stabilized lithium metal powder (SLMP) coating process.

As described above, according to certain aspects, the second negative electrode active material layer contains the above-described second negative electrode active material and has a mixed composition of a silicon-based active material and a carbon-based active material, so as to take advantage of rapid charging. Especially, according to certain aspects, the second negative electrode active material has a mixed composition, and thus, is highly irreversible, which is advantageous even in the pre-lithiation process of pre-charging the negative electrode. As compared with a case in which only a first negative electrode active material layer is simply applied, the second negative electrode active material layer has the second negative electrode active material having the above composition, which may enable a uniform pre-lithiation process on top of the negative electrode and thus improve the life.

In an exemplary embodiment of the present disclosure, porosities of the first and second negative electrode active material layers may satisfy a range of 10% or greater and 60% or less.

In another exemplary embodiment, the porosities of the first and second negative electrode active material layers may satisfy a range of 10% or greater and 60% or less, preferably 20% or greater and 50% or less, and more preferably 30% or greater and 45% or less.

The porosity varies depending on the compositions and contents of the active materials, conductive materials and binders included in the first and second negative electrode active material layers, and accordingly, the electrode has the electrical conductivity and resistance within appropriate ranges.

An exemplary embodiment of the present disclosure provides a lithium secondary battery including a positive electrode; the negative electrode for a lithium secondary battery according to aspects of the present disclosure; a separator provided between the positive electrode and the negative electrode; and an electrolyte.

The secondary battery according to an exemplary embodiment of the present disclosure may particularly include the negative electrode for a lithium secondary battery described above. Specifically, the secondary battery may include a negative electrode, a positive electrode, a separator interposed between the positive electrode and the negative electrode, and an electrolyte, and the negative electrode is the same as the negative electrode described above. Since the negative electrode has been described above, a detailed description thereof is omitted.

The positive electrode may include a positive electrode current collector layer and a positive electrode active material layer formed on the positive electrode current collector layer and including a positive electrode active material.

In the positive electrode, the positive electrode current collector layer is not particularly limited as long as it has conductivity without causing a chemical change in the battery. For example, stainless steel, aluminum, nickel, titanium, fired carbon, aluminum or stainless steel each surface-treated with carbon, nickel, titanium, silver, or the like, or the like may be used. In addition, the positive electrode current collector layer may typically have a thickness of 3 to 500 μm, and a surface of the current collector may be formed with microscopic irregularities to enhance adhesive force of the positive electrode active material. For example, the positive electrode current collector may be used in various forms such as a film, a sheet, a foil, a net, a porous body, a foamed body, and a non-woven fabric body.

The positive electrode active material may be a positive electrode active material that is typically used. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃F₄; a lithium manganese oxide such as chemical formula Li_{1+c1}Mn_{2-c1}O₄ (0≤c1≤0.33), LiMnO₃, LiMn₂₀₃ and LiMnO₂; a lithium copper oxide (Li₂CuO₂); a vanadium oxide such as LiV₃O₈, V₂O₅ and Cu₂V₂O₇; a Ni-site type lithium nickel oxide represented by chemical formula LiNi_{1-c2}M_{c2}O₂ (where M is at least one selected from the group consisting of Co, Mn, Al, Cu, Fe, Mg, B, and Ga, and satisfies 0.01≤c2≤0.3); a lithium manganese composite oxide represented by chemical formula LiMn_{2-c3}M_{c3}O₂ (where M is at least one selected from the group consisting of Co, Ni, Fe, Cr, Zn and Ta, and satisfies 0.01≤c3≤0.1) or Li₂Mn₃MO₈ (where M is at least one selected from the group consisting of Fe, Co, Ni, Cu and Zn); LiMn₂O₄ in which a part of Li of the chemical formula is substituted with an alkaline earth metal ion, or the like, but is not limited thereto. The positive electrode may be Li metal.

The positive electrode active material layer may include a positive electrode conductive material and a positive electrode binder together with the positive electrode active material described above.

In this case, the positive electrode conductive material is used to impart conductivity to the electrode, and can be used without particular limitation as long as the positive electrode conductive material has electronic conductivity without causing a chemical change in a battery to be constituted. Specific examples may include graphite such as natural graphite and artificial graphite; a carbon-based material such as carbon black, acetylene black, Ketjen black, channel black, furnace black, lamp black, thermal black and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative, or the like, and any one thereof or a mixture of two or more thereof may be used.

In addition, the positive electrode binder serves to improve bonding between particles of the positive electrode active material and adhesive force between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

The separator serves to separate the negative electrode and the positive electrode and to provide a movement path of lithium ions, in which any separator may be used as the separator without particular limitation as long as it is typically used in a secondary battery, and particularly, a separator having high moisture-retention ability for an electrolyte as well as a low resistance to the movement of electrolyte ions may be preferably used. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a usual porous non-woven fabric, for example, a non-woven fabric formed of high melting point glass fibers, polyethylene terephthalate fibers, or the like may be used. Furthermore, a coated separator including a ceramic component or a polymer material may be used to secure heat resistance or mechanical strength, and the separator having a single layer or multilayer structure may be selectively used.

Examples of the electrolyte may include an organic liquid electrolyte, an inorganic liquid electrolyte, a solid polymer electrolyte, a gel-type polymer electrolyte, a solid inorganic electrolyte, or a molten-type inorganic electrolyte that may be used in the manufacturing of the lithium secondary battery, but are not limited thereto.

Specifically, the electrolyte may include a non-aqueous organic solvent and a metal salt.

As the non-aqueous organic solvent, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

In particular, among the carbonate-based organic solvents, ethylene carbonate and propylene carbonate, which are cyclic carbonates, are high-viscosity organic solvents and can be preferably used because they have high permittivity to dissociate a lithium salt well. When the cyclic carbonate is mixed with a linear carbonate with low viscosity and low permittivity, such as dimethyl carbonate and diethyl carbonate, in a suitable ratio and used, an electrolyte having high electric conductivity may be prepared, and therefore, may be more preferably used.

A lithium salt may be used as the metal salt, and the lithium salt is a material that is readily soluble in the non-aqueous electrolyte, in which, for example, one or more species selected from the group consisting of F⁻¹, Cl⁻¹, I⁻¹, NO₃⁻¹, N(CN)₂⁻¹, BF₄⁻¹, ClO₄⁻¹, PF₆⁻¹, (CF₃)₂PF₄⁻¹, (CF₃)₃PF₃⁻¹, (CF₃)₄PF₂⁻¹, (CF₃)₅PF⁻¹, (CF₃)₆P⁻¹, CF₃SO₃⁻¹, CF₃CF₂SO₃⁻¹, (CF₃SO₂)₂N⁻¹, (FSO₂)₂N⁻¹, CF₃CF₂ (CF₃)₂CO⁻¹, (CF₃SO₂)₂CH⁻¹, (SF₅)₃C⁻¹, (CF₃SO₂)₃C⁻¹, CF₃(CF₂)₇SO₃⁻¹, CF₃CO₂⁻¹, CH₃CO₂⁻¹, SCN⁻ and (CF₃CF₂SO₂)₂N⁻ may be used as an anion of the lithium salt.

One or more additives, for example, a haloalkylene carbonate-based compound such as difluoroethylene carbonate, pyridine, triethylphosphite, triethanolamine, cyclic ether, ethylenediamine, n-glyme, hexamethyl phosphoric triamide, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride, may be further included in the electrolyte for the purpose of improving life characteristics of the battery, suppressing a decrease in battery capacity, improving discharge capacity of the battery, and the like, in addition to the above-described electrolyte components.

An exemplary embodiment of the present disclosure provides a battery module including the secondary battery as a unit cell, and a battery pack including the same. Since the battery module and the battery pack include the secondary battery having high capacity, high-rate capability, and high cycle characteristics, the battery module and the battery pack may be used as a power source of a medium to large sized device selected from the group consisting of an electric vehicle, a hybrid electric vehicle, a plug-in hybrid electric vehicle, and a power storage system.

Hereinafter, preferred examples will be provided for better understanding of aspects of the present disclosure. It will be apparent to one skilled in the art that the examples are only provided to illustrate the present disclosure and various modifications and alterations are possible within the scope and technical spirit of the present disclosure. Such modifications and alterations naturally fall within the scope of claims included herein.

### PREPARATION EXAMPLE

### Preparation of Negative Electrode

### Example 1

### Preparation of First Negative Electrode Active Material Layer

Si (average particle diameter (D50): 5 μm) serving as a silicon-based active material, a first conductive material, a second conductive material, and polyacrylamide serving as a binder were added to distilled water serving as a solvent for formation of a negative electrode slurry at a weight ratio of 80:9.5:0.5:10 to prepare a first negative electrode slurry (solid concentration: 25 wt %).

The first conductive material was plate-like graphite (specific surface area: 17 m²/g, average particle diameter (D50): 3.5 μm), and the second conductive material was SWCNT.

As a mixing method, after dispersing the first conductive material, the second conductive material, the binder and water at 2500 rpm for 30 minutes with a homo mixer, the active material was added to the dispersion, which was then dispersed at 2500 rpm for 30 minutes to fabricate a slurry.

The first negative electrode slurry was coated on both surfaces of a copper current collector (thickness: 8 μm) serving as a negative electrode current collector with a loading amount of 50 to 70 mg/25 cm², which was then roll-pressed and dried in a vacuum oven at 130° C. for 10 hours to form a first negative electrode active material layer.

### Preparation of Second Negative Electrode Active Material Layer

A second negative electrode active material layer composition was prepared using SiO (average particle diameter (D50): 3.5 μm) as a silicon-based active material, a first conductive material, a second conductive material, and polyacrylamide as a binder at a weight ratio of 70:19.8:0.2:10. A second negative electrode slurry was prepared by adding the composition to distilled water as a solvent for formation of a negative electrode slurry (solid concentration: 25 wt %).

The first conductive material was plate-like graphite (specific surface area: 17 m²/g, average particle diameter (D50): 3.5 μm), and the second conductive material was carbon nanotubes.

As a mixing method, after dispersing the first conductive material, the second conductive material, the binder and water at 2500 rpm for 30 minutes with a homo mixer, the active material was added to the dispersion, which was then dispersed at 2500 rpm for 30 minutes to fabricate a slurry.

The second negative electrode slurry was coated on the first negative electrode active material layer with a loading amount of 15 to 40 mg/25 cm², which was then roll-pressed and dried in a vacuum oven at 130° C. for 10 hours to form a second negative electrode active material layer (thickness: 15 μm).

In this case, the core thickness and liquid thickness (coating liquid thickness) of the coating composition are as shown in Table 1 below, and the corresponding Formula 1 is also shown in Table 1 below.

TABLE 1

| | Liquid thickness of | | | | | | | |
|---|---|---|---|---|---|---|---|---|
| | coating composition | | | | | | | |
| | (coating liquid | | Core thickness of | | | | | |
| | thickness, μm) | | coating composition (T) | | | | | |
| | first | second | first | second | | | | |
| | negative | negative | negative | negative | | | | |
| | electrode | electrode | electrode | electrode | | | | |
| | active | active | active | active | Formula 1 | | | |
| | material | material | material | material | A | B | C | Formula 1 |
| | layer | layer | layer | layer | (μm) | (μm) | (μm) | (μm) |
| Example 1 | 75 | 35 | 1T | 1T | 18.6 | 7.4 | 13.6 | 0.6 |
| Example 2 | 72 | 36 | 1.5T | 1.5T | 16.5 | 8.2 | 14.5 | 2.15 |
| Example 3 | 79 | 26 | 0.8T | 1T | 19 | 7 | 13.8 | 0.8 |
| Example 4 | 62 | 37 | 0.5T | 1T | 15.9 | 7 | 14.2 | 2.75 |
| Comparative | 52 | 42 | 1T | 1T | 26 | 4 | 26 | 11 |
| Example 1 | | | | | | | | |
| Comparative | 86 | 54 | 2.1T | 2.1T | 29 | 6 | 28.3 | 14.15 |
| Example 2 | | | | | | | | |

### Preparation of Secondary Battery

A positive electrode slurry (solid concentration: 78 wt %) was prepared by adding LiNi_{0.6}CO_{0.2}Mn_{0.2}O₂ (average particle diameter (D50): 15 μm) as a positive electrode active material, carbon black (product name: Super C65, manufacturer: Timcal) as a conductive material, and polyvinylidene fluoride (PVdF) as a binder to N-methyl-2-pyrrolidone (NMP) as a solvent for formation of a positive electrode slurry at a weight ratio of 97:1.5:1.5.

The positive electrode slurry was coated on both surfaces of an aluminum current collector (thickness: 12 μm) serving as a positive electrode current collector with a loading amount of 537 mg/25 cm², which was then roll-pressed and dried in a vacuum oven at 130° C. for 10 hours to form a positive electrode active material layer (thickness: 65 μm), whereby a positive electrode was prepared (thickness of positive electrode: 77 μm, porosity: 26%).

A lithium secondary battery was manufactured by interposing a polyethylene separator between the positive electrode and the negative electrode of the Examples and the Comparative Examples and injecting an electrolyte.

The electrolyte was obtained by adding vinylene carbonate to an organic solvent, in which fluoroethylene carbonate (FEC) and diethyl carbonate (DMC) were mixed at a volume ratio of 30:70, in an amount of 3 wt % based on a total weight of the electrolyte and adding LiPF₆ as a lithium salt to a concentration of 1M.

### Experimental Example 1: Evaluation of Life Characteristics

For the secondary batteries including the negative electrodes manufactured in the Examples and Comparative Examples, the life and capacity retention rate were evaluated using an electrochemical charging and discharging device. The in-situ cycle test was conducted on the secondary battery at 4.2-3.0 V 1 C/0.5 C, and during the test, 0.33 C/0.33 C charging/discharging (4.2-3.0 V) was performed every 50 cycles to measure the capacity retention rate. In Table 2 below, the in-situ capacity retention rate, not the RPT capacity retention rate, is indicated.

capacity retention rate (%)={(discharge capacity in the Nth cycle)/(discharge capacity in the first cycle)}×100

### Experimental Example 2: Evaluation of Resistance Increase Rate Measurement

In the test in Experimental Example 1, the capacity retention rate was measured by charging/discharging (4.2-3.0V) the battery at 0.33 C/0.33 C every 50 cycles, and then the resistance increase rate was compared and analyzed by discharging the battery with a pulse of 2.5 C at SOC50 to measure the resistance.

In addition, for the life characteristic evaluation and the resistance increase rate measurement evaluation, data was calculated at 200 cycles, respectively, and the results are shown in Table 2 below.

TABLE 2

| | Capacity retention | Resistance increase |
|---|---|---|
| | rate evaluation | rate |
| | (%, @200 cycles) | (%, @200 cycles) |
| Example 1 | 90.76 | 1.43 |
| Example 2 | 89.1 | 2.21 |
| Example 3 | 90.6 | 1.7 |
| Example 4 | 88.5 | 2.52 |
| Comparative Example 1 | 87 | 3.7 |
| Comparative Example 2 | 86.5 | 4.1 |

As can be seen in Tables 1 and 2, in the case of the negative electrodes according to the Examples of the present disclosure, the second negative electrode active material layer satisfies the non-uniformity criteria of Formula 1 above. In other words, the first negative electrode active material layer has a silicon-based negative electrode and is coated within a thin thickness range. In this case, there was a problem in forming the second negative electrode active material layer as a thin film on top of the silicon-based negative electrode. However, when performing coating by the method as in Table 1 (by controlling a liquid thickness and a core thickness of the coating composition), the non-uniformity criteria of Formula 1 above is satisfied, and the second negative electrode active material layer can be coated more uniformly and thinly on top of the first negative electrode active material layer.

Accordingly, it could be confirmed that the lithium secondary battery including the negative electrode had optimal capacity characteristics, which are the advantage of a Si negative electrode, and at the same time improved cycle characteristics and resistance increase rate.

In the case of Comparative Example 1 and Comparative Example 2, each exceeds the range of Formula 1 of the present disclosure. That is, the structure in which the second negative electrode active material layer is formed is the same, but the coating is not uniform compared to Examples 1 to 4. In this case, it could be confirmed that the capacity and life could be improved compared to the general negative electrode having a single-layer structure, but the capacity retention rate and the resistance increase rate were not good compared to Examples 1 to 4 of the present disclosure. This corresponds to the result of the second negative electrode active material layer, which serves as a buffer layer, being coated non-uniformly on top of the first negative electrode active material layer.

1. A negative electrode for a lithium secondary battery, the negative electrode comprising:
a negative electrode current collector layer:
a first negative electrode active material layer provided on a surface of the negative electrode current collector layer; and
a second negative electrode active material layer provided on a surface of the first negative electrode active material layer opposite to a surface of the first negative electrode active material layer facing the negative electrode current collector layer,
wherein the first negative electrode active material layer comprises a first negative electrode active material layer composition comprising a first negative electrode active material, and the second negative electrode active material layer comprises a second negative electrode active material layer composition comprising a second negative electrode active material,
wherein the first negative electrode active material comprises one or more selected from the group consisting of SiOx (x=0) and SiOx (0<x<2), and comprises the SiOx (x=0) in an amount of 95 parts by weight or more based on 100 parts by weight of the first negative electrode active material,
wherein the second negative electrode active material comprises a mixture of one or more selected from the group consisting of a carbon-based active material, a silicon-based active material, a metal-based active material capable of alloying with lithium, and a lithium-containing nitride,
wherein the second negative electrode active material layer has a first surface and a second surface, and wherein the second surface of the second negative electrode active material layer is facing the first negative electrode active material layer, and the first surface of the second negative electrode active material is opposite to the second surface,
wherein the first surface and the second surface each comprise a non-uniform surface, respectively, and
wherein the second negative electrode active material layer satisfies a non-uniformity criteria expressed by Formula 1 below:
$$0 μm \leq \vert C - ( A + B / 2 ) \vert \leq 10 μm \qquad Formula 1$$
in the Formula 1,
A refers to a longest distance (μm) between the first surface and the second surface,
B refers to a shortest distance (μm) between the first surface and the second surface, and
C refers to an average thickness (μm) of the second negative electrode active material layer.

2. The negative electrode for a lithium secondary battery of claim 1, wherein the A is 5 μm or greater and 25 μm or less, and
wherein the C is 5 μm or greater and 20 μm or less.

3. The negative electrode for a lithium secondary battery of claim 1, wherein the average thickness of the second negative electrode active material layer is 10% or greater and 40% or less of a total thickness of the first negative electrode active material layer and the second negative electrode active material layer.

4. The negative electrode for a lithium secondary battery of claim 1, wherein an average surface roughness (Sa) of the first surface is 700 nm or less.

5. The negative electrode for a lithium secondary battery of claim 1, wherein the second negative electrode active material comprises a mixture of one or more selected from the group consisting of a carbon-based active material, a silicon-based active material, a metal-based active material capable of alloying with lithium, and a lithium-containing nitride, and the silicon-based active material is included in an amount of 50 parts by weight or more and 100 parts by weight or less based on 100 parts by weight of the second negative electrode active material.

6. The negative electrode for a lithium secondary battery of claim 1, wherein the silicon-based active material comprises one or more selected from the group consisting of SiOx (0<x<2), SiC, and a Si alloy.

7. The negative electrode for a lithium secondary battery of claim 1,
wherein the silicon-based active material comprises SiOx (0<x<2).

8. The negative electrode for a lithium secondary battery of claim 1, wherein the first negative electrode active material is included in an amount of 60 parts by weight or more based on 100 parts by weight of the first negative electrode active material layer composition.

9. The negative electrode for a lithium secondary battery of claim 1, wherein a viscosity of the first negative electrode active material layer composition is a shear viscosity of 2,000 cPs or higher and 15,000 cPs or less at a shear rate of 2.5 (l/s), and
wherein a viscosity of the second negative electrode active material layer composition is lower than the viscosity of the first negative electrode active material layer composition.

10. The negative electrode for a lithium secondary battery of claim 1, wherein the first negative electrode active material layer is formed on an entire surface of the negative electrode current collector layer, and
wherein the second negative electrode active material layer is formed on an entire surface of the first negative electrode active material layer.

11. A method for manufacturing a negative electrode for a lithium secondary battery, the method comprising:
preparing a negative electrode current collector layer:
forming a first negative electrode active material layer by applying a first negative electrode active material layer composition to surface of the negative electrode current collector layer using a first coating composition; and
forming a second negative electrode active material layer by applying a second negative electrode active material layer composition to a surface of the first negative electrode active material layer opposite to a surface of the first negative electrode active material layer that is in contact with the negative electrode current collector layer using a second coating composition,
wherein the first negative electrode active material includes one or more selected from the group consisting of SiOx (x=0) and SiOx (0<x<2), and includes SiOx (x=0) in an amount of 95 parts by weight or more on the basis of 100 parts by weight of the first negative electrode active material,
wherein the second negative electrode active material includes a mixture of one or more selected from the group consisting of a carbon-based active material, a silicon-based active material, a metal-based active material capable of alloying with lithium, and a lithium-containing nitride,
wherein in the forming of the first negative electrode active material layer by applying the first negative electrode active material layer composition, a liquid thickness of the first coating composition is 50 μm or greater and 100 μm or less, and
wherein in the forming of the second negative electrode active material layer by applying the second negative electrode active material layer composition to the surface of the first negative electrode active material layer opposite to the surface in contact with the negative electrode current collector layer, a liquid thickness of the second coating composition is 10 μm or greater and 60 μm or less.

12. The method of claim 11, wherein a core thickness of the first or second coating composition is 0.4 T or greater and 2 T or less.

13. The method of claim 11, comprising pre-lithiating a negative electrode having the first negative electrode active material layer and second negative electrode active material layer formed on the negative electrode current collector,
wherein the pre-lithiating of the negative electrode comprises a lithium electroplating process, a lithium metal transfer process, a lithium metal deposition process, or a stabilized lithium metal powder (SLMP) coating process.

14. The method of claim 11, wherein the forming the second negative electrode active material layer on the first negative electrode active material layer comprises a wet on dry process, and
wherein the wet on dry process comprises:
applying the first negative electrode active material layer composition;
forming the first negative electrode active material layer by drying partially or completely the applied first negative electrode active material layer composition; and
applying the second negative electrode active material layer composition to the first negative electrode active material layer.

15. The method of claim 11, wherein forming second negative electrode active material layer on the first negative electrode active material layer comprises a wet on wet process, and
wherein the wet on wet process comprises:
applying the first negative electrode active material layer composition; and
applying the second negative electrode active material layer composition to the first negative electrode active material layer composition in an undried state of the first negative electrode active material layer composition.

16. A lithium secondary battery comprising:
a positive electrode;
the negative electrode for a lithium secondary battery of claim 1;
a separator provided between the positive electrode and the negative electrode; and
an electrolyte.
